(19) United States
(12) Patent Application Publication
(10) Pub. No.: US 2015/0013817 A1
(43) Pub. Date: Jan. 15, 2015

(54) Actuated Moment Arm

(71) Applicant: Larry McMurray, Hugo, MN (US)

(72) Inventor: Larry McMurray, Hugo, MN (US)

(21) Appl. No.: 14/329,629

(22) Filed: Jul. 11, 2014

Related U.S. Application Data
(60) Provisional application No. 61/845,721, filed on Jul. 12, 2013.

(51) Int. Cl. F16L 11/12

(52) U.S. Cl. CPC F16L 11/12
USPC 138/108; 138/118.1

(57) ABSTRACT

The actuated moment arm is a flexible, sturdy, and durable rod with at least one center support member, a plurality of tendon rod members surrounding the center support member, an outer housing surrounding and constraining the tendon members, and one or more clamping means situated within the arm or at points along the arm to constrict movement of the center support member, tendon rod members and outer housing.

This application claims the filing date of and relates to the provisional application by the same inventor, Ser. No. 61/845,721 filed on Jul. 12, 2013.

### BACKGROUND OF THE INVENTION

### Field of the Invention

This invention relates to a flexible actuated moment arm.

### SUMMARY OF THE INVENTION

The actuated moment arm is comprised of at least one center support member, a plurality of tendon rod members surrounding the center support member, an outer housing surrounding and constraining the tendon members, and one or more clamps situated at points along the arm to constrict movement of the center support member, tendon rod members and outer housing at the location of the clamp. The one or more center support members can be solid or hollow. A hollow center support member would be preferred when the arm is used as conduit for wiring, fluids or the like. The actuated moment arm works by bending the arm to a desired arch shape and clamping the at a point, thereby pinching the tendon rod members to prevent further movement of the tendon rod members at the point of the clamping, whereby the arch is maintained in that fixed position. Clamping the arm can be accomplished with any clamping means, such as a cable clamp, wire clamp, hose clamp or any type of clamping means that can constrict a point along the arm, compressing the outer housing and tendon rod members to restrict movement at the point of clamping. The tendon rod members are preferably made of fiberglass rod; however, any geometric cross sectional shaped member, sheet, rectangular, square, circular, oval, etc. that is a strong, flexible, non-deforming material can be used.

Additional means to freeze the arch include an adjustable strut to hold the starting and ending of the arch. The tendon rod members still are unconstrained and allowed to flex between the arch's starting and ending tangent points. Using an adjustable strut allows the use of a minimum of one tendon rod member between constraint points.

In operation, one or more tendon rod members are constrained by a clamping means at a start point and an end point to retain a bending moment between the points. The arm between these points is unconstrained, which allows the tendon rod member to absorb energy and impacts, similar to a bent spring, which vary the curvature of the arch depending on forces applied to the constraints at either end. An adjustable strut can be placed between each end of the arm to change the curvature of the arch prior to securing the end constraints. Tendon rod members may also be captive within a compressible or expandable housing allowing members to move or shift parallel to one another if the radius of the housing increases of decreases.

### DETAILED DESCRIPTION OF DRAWINGS

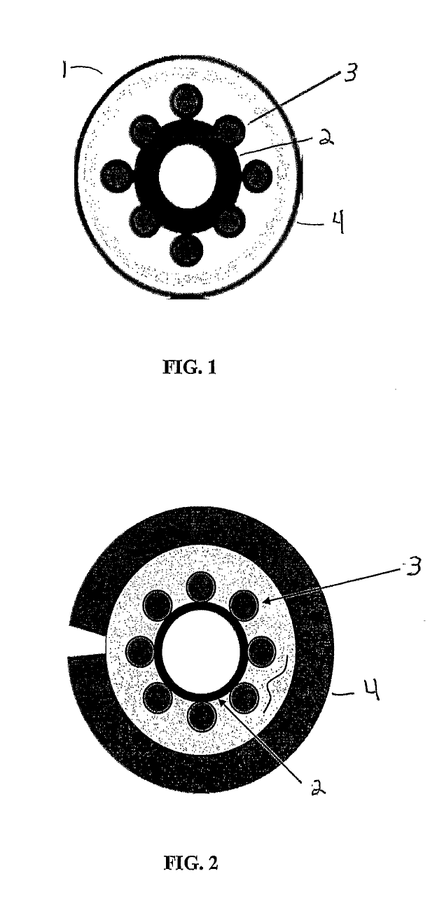

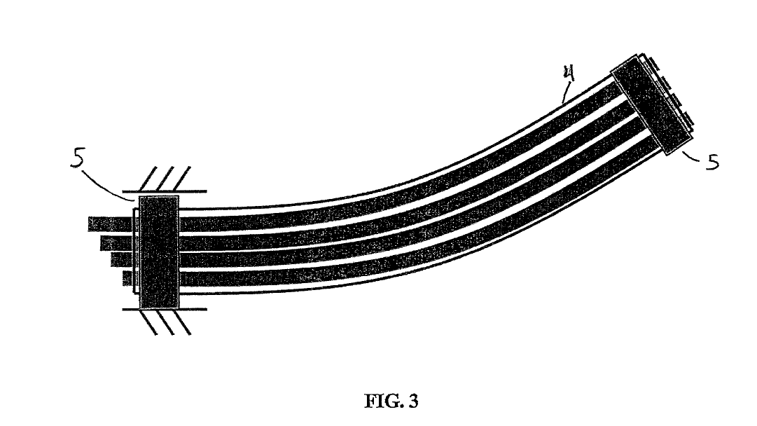

Referring to FIGS. 1 and 2, a cross section of the actuated moment arm 1 is shown, comprising a hollow center support member 2, a plurality of tendon rod members 3 surrounding the hollow center support member 2, an outer housing 4 surrounding and constraining the tendon members, and one or more clamps 5 (not shown in FIG. 1 or 2) situated at points along the arm 1. The clamps 5 are shown in FIG. 3.

Referring back to FIGS. 1 and 2, the plurality of tendon rod members 3, which are positioned independently next to each other, having independent bending moments, are constrained together to change the members to become a solo member causing any additional bending moment to be greater than the sum of the unconstrained members.

Referring to FIG. 3, the plurality of tendon rod members 3 are shown positioned independently next to each other, each having independent bending moments, and are constrained by clamps 5 after being arched, to form an arch with the rigid properties of that of one tendon rod member.

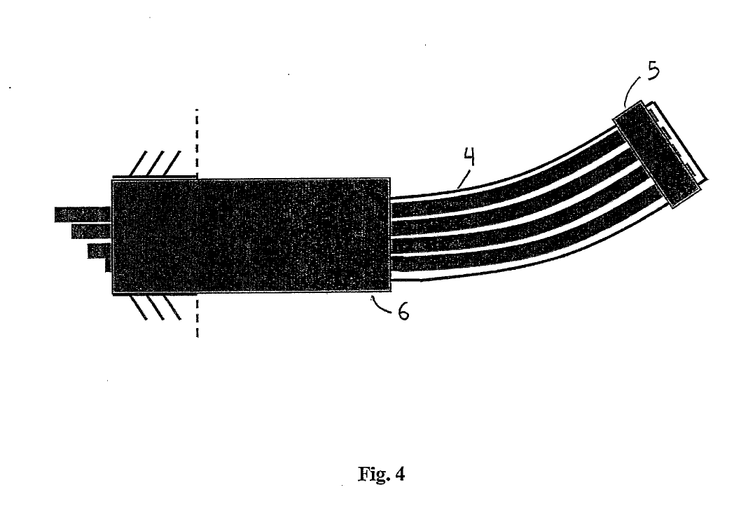

Referring to FIG. 4, a rigid extended housing 6 is shown that limits where the radial arch of the arm occurs.

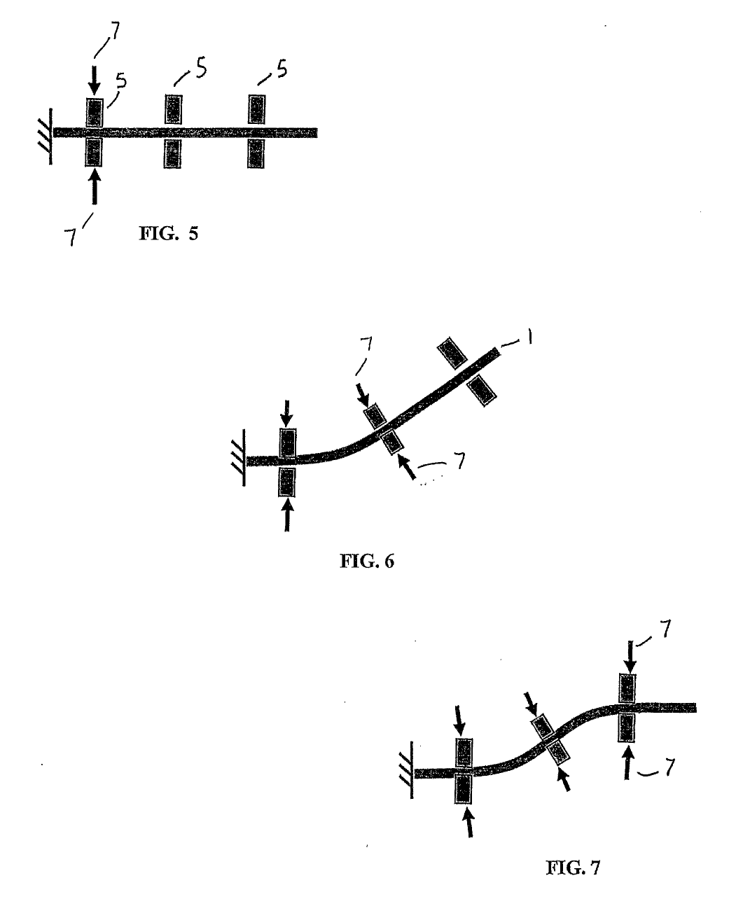

Referring to FIGS. 5, 6 and 7, the arm 1 is shown with a plurality of clamps 5. The arm 1 can be bent in a variety of arches for use in a variety of applications. The dark arrows 7 indicate that the clamp is tight, constraining the tendon rod members to allow bending of the arm 1 in different configurations.

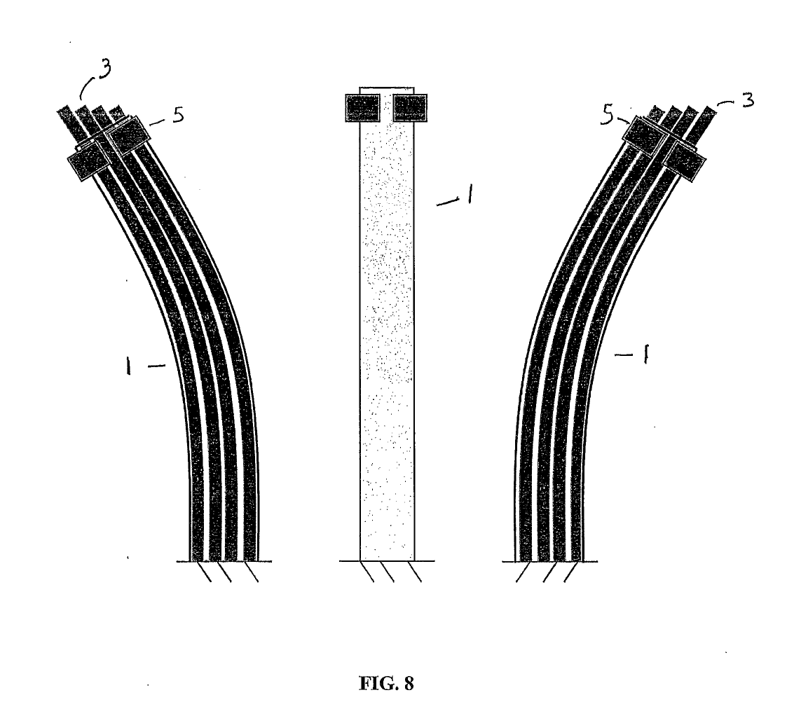

Referring to FIG. 8, an actuated moment arm 1 is shown without any force applied and without the clamp 5 tightened in the center; and on the right shows the arm 1 with a force applied to the right, showing movement of the tendon rod members 3 when that force is applied, and further showing the resulting bend of the arm 1 after the clamp 5 is tightened; and on the left shows the arm 1 with a force applied to the left, showing movement of the tendon rod members 3 when that force is applied, and further showing the resulting bend of the arm 1 after the clamp 5 is tightened.

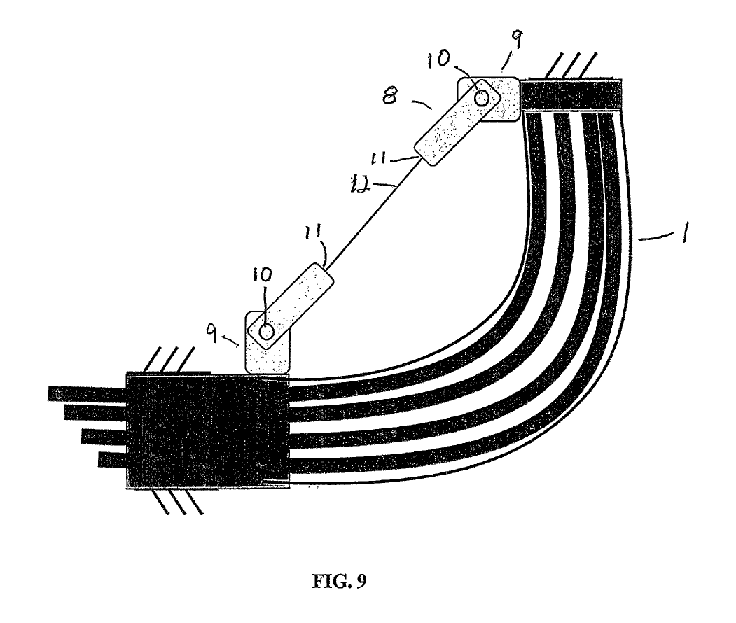

Referring now to FIG. 9, the arm 1 is shown with a bend of about 90 degrees and includes a brace 8 that is used to adjust the radius of the bend. The brace 8 is adjustable and comprises two ends 9, each end 9 being attached to the arm 1 and further comprising swivel means 10 to allow adjustment to the radius of the bend of the arm 1. The brace 8 further comprises at least one adjustable means 11 and an adjustable means wire 12 whereby the adjustable means 11 can lengthen or shorten the adjustable means wire 12 thereby forcing portions of the arm 1 closer together or allowing portions of the arm 1 to relax, thus adjusting the radius of the bend of the arm 1. The ends 9 can be removably or fixedly attached to a clamp, or to the outer housing, or to the arm by some other means. In another embodiment, a threaded turnbuckle would replace the adjustable means wire 12, thereby allowing either a compression or tension adjustment to the arm 1.

The arm 1 can also be secured or clamped at one end, allowing a variety of bends or arches along the arm, dependent upon the number and placement of clamps. Likewise, multiple arms can be connected to one another, thereby expanding its uses.

Another embodiment of the actuated moment arm would include an adjustable strut which would allow the use of a minimum of one tendon rod member between constraint points.

A further embodiment would include the center support member comprising a hollow center support member, which would allow a passage way for transfers such as, fluid, air, electric wire, optic cable, tension, compression or rotational force members. The hollow center support member would allow uses of the arm as a delivery channel to transfer or deliver a product, such as compressed air, a vacuum or suction means, granular type material, liquids or anything that is flexible or fluid inside a tube.

The hollow center support member would also allow uses of the arm as a utility channel to house, shield or support electric wires, rotary power torque cables, hydraulic lines, fiber optic cable and other flexible utilities.

The preferred embodiment with a solid center support member would allow uses as a structural support member to support or position loads at variable angles.

Other embodiments would include two or more flexible tendon rod members positioned independently next to each other with each tendon rod member a geometrical cross section that limit the bending moment to a 2 dimensional plane (flat straps as an example); two or more flexible tendon rod members positioned independently next to each other with round cross section having no outer housing constraints on outer periphery of the flexible tendon rod members between constrains allowing the tendon rod members to flex freely to any torsional force.

The arm when not constrained will spring back to original unconstrained position, straight or parallel to one another so they can be placed in a linear position to minimize storage area, thus allowing storage in a long narrow bag.

One, of many, uses of the actuated moment arm is as a frame for a boat Bimini top. Current Bimini tops have a boot to cover the canvas but the frame tubing legs must protrude from the cover and allows insects, mostly dock spiders, an ideal nesting environment. The present invention would allow air or watertight storage, preventing the elements and insects from coming into contact with the Bimini.

The flexible tendon rod members can be different diameters. Using smaller diameter tendon rod members will allow a smaller radius without exceeding the member's yield. The number of tendon rod members can also vary in each arm to provide more or less bend or support. Adding additional tendon rod members would increase proportionately the amount of stress load. For example; normally, flex material members are selected first by stress load requirements and after selection has been chosen, the engineer will determine a set maximum bend radius at which the flex material will yield or at which point permanent damage will occur to the flex material member. With this invention, an engineer can select the required radius first and then add additional tendon rod members to achieve the desired load.

The outer housing could be PEX tubing or any similar type material which is flexible for tight radius applications and non-abrasive for vinyl covering.

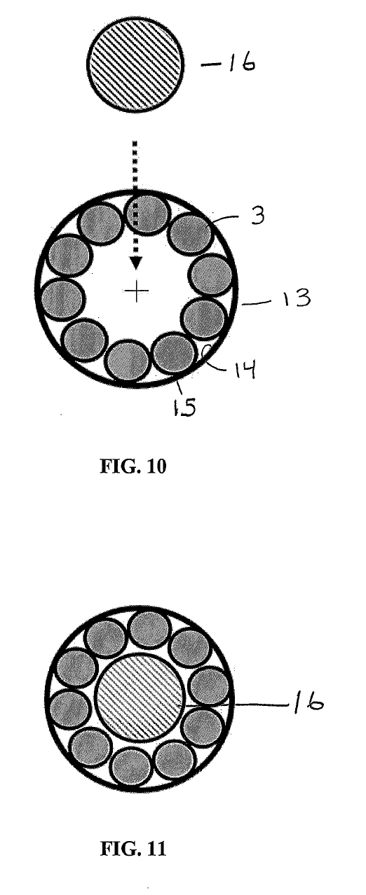

A further embodiment is shown in FIGS. 10 through 16.

Referring to FIG. 10, a plurality of the tendon rod members 3 are arranged in a circular pattern within a flexible and deformable tubing 13, such as surgical tubing, the surgical tubing having an inner diameter 14 and an outer diameter 15, and the arrangement of the tendon rod members having an outside diameter that is slightly larger than the inner diameter of the surgical tubing, thus being held in a perfect circle due to the geometry of the pattern of the tendon rod members. The formed circle of the tendon rod members thus has an inside diameter along the entire length of the actuated moment arm.

FIG. 11 shows a center round member 16, having a diameter slightly smaller than the inside diameter of the tendon rod members circular pattern, that can slide freely within the tendon rod members circular pattern.

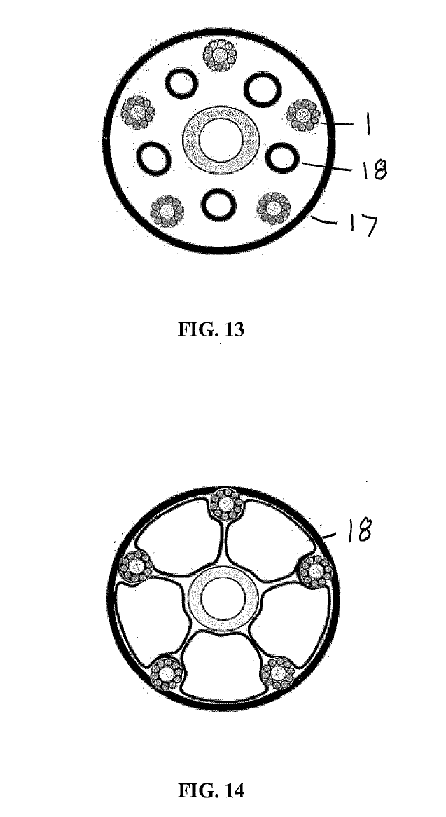

The flexible deformable tubing with the circular arrangement of tendon rod members allows a plurality of such actuated moment arms to be placed within a flexible and non-deformable housing 17, as shown in FIG. 13, with air or fluid bladders 18 being placed alongside the actuated moment arms within the flexible and non-deformable housing, thus allowing pressurized air or other fluids to be pumped into the bladders, thereby putting pressure on the plurality of actuated moment arms, as shown in FIG. 14, thereby acting as a clamping mechanism making the actuated moment arms rigid along the length of the pressurized area. Thus, the plurality of actuated moment arms, arranged as such within the flexible and non-deformable housing with the bladders, can be bent, manipulated or turned in multiple ways and frozen in that bent or turned position when pressurized air or fluid is applied, and unfrozen when the pressure is released. The air or fluid bladders could be any expandable, or swelling or ballooning capable means that can hold pressurized air or fluid and expand against the actuated moment arms when the pressurized air or fluid is fed into the expandable, swelling or ballooning means, thereby placing a clamping force against and around the actuated moment arms, making the actuated moment arms rigid.

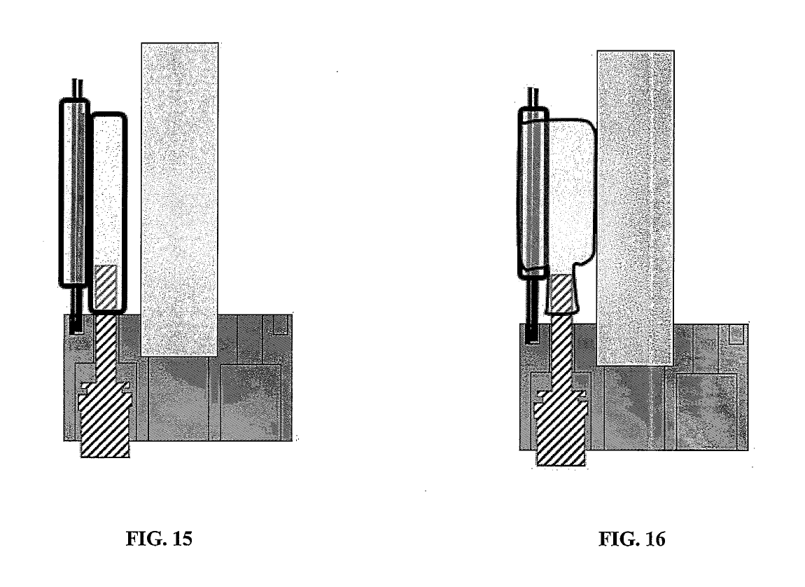

FIGS. 15 and 16 show a side view of the expandable, swelling or ballooning means before it is inflated, FIG. 15, and after it is inflated, FIG. 16, with pressurized air or other fluid.

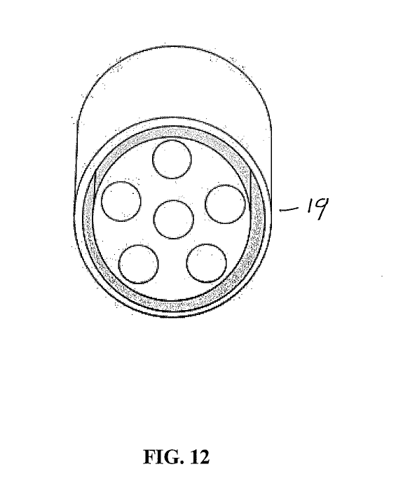

A liquid or air pressure distribution manifold means 19 is shown in FIG. 12.

Another embodiment would replace the bladders or expandable, or swelling or ballooning capable means with a mechanically expandable means, rather than using pressurized air or fluid. Thus, the mechanical means, also shown as 18 in FIGS. 13 and 14, would push or expand against the actuated moment arms, acting as a clamping means. The mechanical means could be powered by any force, such as, but not limited to, electric, magnetic or hydraulic.

I claim:

1. An actuated moment arm comprising at least one center support member, a plurality of tendon rod members surrounding the center support member, an outer housing surrounding and constraining the tendon rod members, and one or more clamping means to constrict movement of the center support member, the tendon rod members, and the outer housing.

2. The actuated moment arm of claim 1 wherein the center support member is hollow.

3. The actuated moment arm of claim 1 wherein the center support member is solid.

4. The actuated moment arm of claim 1 wherein the tendon rod members are made of a strong, flexible, non-deforming material.

5. The actuated moment arm of claim 4 wherein the strong, flexible, non-deforming material is fiberglass.

6. The actuated moment arm of claim 1 wherein the tendon rod members comprise a geometric cross sectional shape.

7. The actuated moment arm of claim 1 further comprising an adjustable brace, the adjustable brace comprising two ends, an adjustable means wire connecting the two ends of the brace, and at least one adjustable means situated along the adjustable means wire to tighten or loosen the adjustable means wire,
each end of the adjustable brace being separately attached to one of the external clamps,
the actuated moment arm, or to the outer housing.

8. The actuated moment arm of claim 1 wherein the two or more flexible tendon rod members comprise a geometrical cross section that limit the bending moment to a two-dimensional plane.

9. The actuated moment arm of claim 1 wherein the clamping means is an external clamping means situated at points along the outer housing of the actuated moment arm to constrict movement of the center support member, the tendon rod members, and the outer housing at the location of the external clamping means.

10. The actuated moment arm of claim 9 wherein the external clamping means is one or more of a cable clamp, a wire clamp, an adjustable strut, or a hose clamp.

11. The actuated moment arm of claim 1 wherein a space is defined between the outer housing and the tendon rod members and the clamping means comprises an internal clamping means disposed within the defined space,
the internal clamping means comprising one or more air or liquid bladders whereby pressurized air or liquid can be pumped into the bladder, pressing the tendon rod members against the outer housing to constrict movement of the center support member, the tendon rod members, and the outer housing.

12. The actuated moment arm of claim 11 wherein the internal clamping means comprises a mechanically expandable means to push or expand against the tendon rod members.

13. The actuated moment arm of claim 12 wherein the mechanically expandable means is electrically, magnetically, or hydraulically powered.
